(19) United States
(12) Patent Application Publication
(10) Pub. No.: US 2025/0056482 A1
(43) Pub. Date: Feb. 13, 2025

(54) RADIO RESOURCE MANAGEMENT MEASUREMENT FOR LOW POWER HIGH FREQUENCY ACCURACY POSITIONING WITH A SUBSTANTIALLY EXTENDED DISCONTINUOUS RECEPTION CYCLE

(71) Applicant: Nokia Technologies Oy, Espoo (FI)

(72) Inventors: Gilsoo LEE, Naperville, IL (US); Hyun-Su CHA, Naperville, IL (US)

(21) Appl. No.: 18/796,086

(22) Filed: Aug. 6, 2024

Related U.S. Application Data
(60) Provisional application No. 63/531,856, filed on Aug. 10, 2023.

(51) Int. Cl. H04W 64/00; H04W 24/08

(52) U.S. Cl. CPC H04W 64/00; H04W 24/08

(57) ABSTRACT

Systems, methods, apparatuses, and computer program products for low power high frequency accuracy positioning with a substantially extended discontinuous reception cycle. The method may include obtaining a first condition related to additional radio resource management measurements and determining whether at least part of the first condition triggering the additional radio resource management measurements is met. The method may further include in response to at least part of the first condition being met, performing the additional radio resource management measurements. The additional radio resource management measurements are outside of a set of periodic paging time windows. The additional radio resource management measurements are performed for at least one of performing positioning measurements or transmitting positioning sounding reference signals.

### FIELD

Some example embodiments may generally relate to mobile or wireless telecommunication systems, such as Long Term Evolution (LTE) or fifth generation (5G) radio access technology or new radio (NR) access technology, or other communications systems such as future wireless communication networks. For example, certain example embodiments may relate to apparatuses, systems, and/or methods for radio resource management measurement for low power high frequency accuracy positioning with a substantially extended discontinuous reception cycle.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

When a device has an extended discontinuous reception (eDRX) cycle, there are large amounts of time when the device is sleeping or otherwise performing limited functions. It can be time consuming for the device to become synchronized with a network or other devices trying to communicate with the device due to the limited window for reception.

### SUMMARY

An embodiment may be directed to an apparatus. The apparatus may include at least one processor and at least one memory storing instructions. The instructions stored in the at least one memory, when executed by the at least one processor may cause the apparatus at least to perform obtaining a first condition related to additional radio resource management measurements and determining whether at least part of the first condition triggering the additional radio resource management measurements is met. The apparatus may further perform in response to at least part of the first condition being met, performing the additional radio resource management measurements. The additional radio resource management measurements are outside of a set of periodic paging time windows. The additional radio resource management measurements are performed for at least one of performing positioning measurements or transmitting positioning sounding reference signals.

Another embodiment may be directed to an apparatus. The apparatus may include at least one processor and at least one memory storing instructions. The instructions stored in the at least one memory, when executed by the at least one processor may cause the apparatus at least to perform determining a first condition related to additional radio resource management measurements and providing or configuring the first condition to one or more user equipment. The apparatus may further perform receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements may be performed in response to at least part of the first condition being met.

Another embodiment may be directed to an apparatus. The apparatus may include at least one processor and at least one memory storing instructions. The instructions stored in the at least memory, when executed by the at least one processor may cause the apparatus at least to perform receiving positioning measurements of a user equipment and evaluating accuracy of the received positioning measurements. The apparatus may further perform based at least in part on the evaluated accuracy, requesting a network entity to configure a first condition related to additional radio resource management measurements to the user equipment.

An embodiment may be directed to a method. The method can include obtaining a first condition related to additional radio resource management measurements and determining whether at least part of the first condition triggering the additional radio resource management measurements is met. The method may further include in response to at least part of the first condition being met, performing the additional radio resource management measurements. The additional radio resource management measurements may be outside of a set of periodic paging time windows. The additional radio resource management measurements may be performed for at least one of performing positioning measurements or transmitting positioning sounding reference signals.

Another embodiment may be directed to a method. The method can include determining, by a network entity, a first condition related to additional radio resource management measurements and providing or configuring the first condition to one or more user equipment. The method may further include receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements may be performed in response to at least part of the first condition being met.

Another embodiment may be directed to a method. The method can include receiving positioning measurements of a user equipment and evaluating accuracy of the received positioning measurements. The method may further include based at least in part on the evaluated accuracy, requesting a network entity to configure a first condition related to additional radio resource management measurements to the user equipment.

Another embodiment may be directed to an apparatus. The apparatus may include means for obtaining a first condition related to additional radio resource management measurements and means for determining whether at least part of the first condition triggering the additional radio resource management measurements is met. The apparatus may further include means for performing the additional radio resource management measurements in response to at least part of the first condition being met. The additional radio resource management measurements may be outside of a set of periodic paging time windows. The additional radio resource management measurements may be performed for at least one of performing positioning measurements or transmitting positioning sounding reference signals.

Another embodiment may be directed to an apparatus. The apparatus may include means for determining, by a network entity, a first condition related to additional radio resource management measurements and means for providing or configuring the first condition to one or more user equipment. The apparatus may further include means for receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements may be performed in response to at least part of the first condition being met.

Another embodiment may be directed to an apparatus. The apparatus may include means for receiving positioning measurements of a user equipment and means for evaluating accuracy of the received positioning measurements. The apparatus may further include means for requesting a network entity to configure a first condition related to additional radio resource management measurements to the user equipment based at least in part on the evaluated accuracy.

Another embodiment may be directed to an apparatus comprising circuitry configured to perform a method. The method can include obtaining a first condition related to additional radio resource management measurements and determining whether at least part of the first condition triggering the additional radio resource management measurements is met. The method may further include in response to at least part of the first condition being met, performing the additional radio resource management measurements. The additional radio resource management measurements may be outside of a set of periodic paging time windows. The additional radio resource management measurements may be performed for at least one of performing positioning measurements or transmitting positioning sounding reference signals.

Another embodiment may be directed to an apparatus comprising circuitry configured to perform a method. The method can include determining a first condition related to additional radio resource management measurements and providing or configuring the first condition to one or more user equipment. The method may further include receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements are performed in response to at least part of the first condition being met.

Another embodiment may be directed to an apparatus comprising circuitry configured to perform a method. The method can include receiving positioning measurements of a user equipment and evaluating accuracy of the received positioning measurements. The method may further include based at least in part on the evaluated accuracy, requesting a network entity to configure a first condition related to additional radio resource management measurements to the user equipment.

Another embodiment may be directed to a non-transitory computer readable medium comprising program instructions stored thereon that, when executed by an apparatus, cause the apparatus to perform at least a method. The method can include obtaining a first condition related to additional radio resource management measurements and determining whether at least part of the first condition triggering the additional radio resource management measurements is met. The method may further include in response to at least part of the first condition being met, performing the additional radio resource management measurements. The additional radio resource management measurements may be outside of a set of periodic paging time windows. The additional radio resource management measurements may be performed for at least one of performing positioning measurements or transmitting positioning sounding reference signals.

Another embodiment may be directed to a non-transitory computer readable medium comprising program instructions stored thereon that, when executed by an apparatus, cause the apparatus to perform at least a method. The method can include determining, by a network entity, a first condition related to additional radio resource management measurements and providing or configuring the first condition to one or more user equipment. The method may further include receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements may be performed in response to at least part of the first condition being met.

Another embodiment may be directed to a non-transitory computer readable medium comprising program instructions stored thereon that, when executed by an apparatus, cause the apparatus to perform at least a method. The method can include receiving positioning measurements of a user equipment and evaluating accuracy of the received positioning measurements. The method may further include based at least in part on the evaluated accuracy, requesting a network entity to configure a first condition related to additional radio resource management measurements to the user equipment.

A computer program comprising instructions, which, when executed by an apparatus, may cause the apparatus to perform a method. The method can include obtaining a first condition related to additional radio resource management measurements and determining whether at least part of the first condition triggering the additional radio resource management measurements is met. The method may further include in response to at least part of the first condition being met, performing the additional radio resource management measurements. The additional radio resource management measurements may be outside of a set of periodic paging time windows. The additional radio resource management measurements may be performed for at least one of performing positioning measurements or transmitting positioning sounding reference signals.

A computer program comprising instructions, which, when executed by an apparatus, may cause the apparatus to perform a method. The method can include determining a first condition related to additional radio resource management measurements and providing or configuring the first condition to one or more user equipment. The method may further include receiving reporting from the one or more user equipment on the additional radio resource management measurements. The additional radio resource management measurements may be outside of a set of periodic paging time windows. The additional radio resource management measurements may be performed for at least one of performing positioning measurements or transmitting positioning sounding reference signals. And the additional radio resource management measurements may be performed in response to at least part of the first condition being met.

A computer program comprising instructions, which, when executed by an apparatus, may cause the apparatus to perform a method. The method can include receiving positioning measurements of a user equipment and evaluating accuracy of the received positioning measurements. The method may further include based at least in part on the evaluated accuracy, requesting a network entity to configure a first condition related to additional radio resource management measurements to the user equipment.

### BRIEF DESCRIPTION OF THE DRAWINGS

For proper understanding of example embodiments, reference should be made to the accompanying drawings, wherein:

FIG. 1 illustrates an example flow diagram of communications between a user equipment and network, according to certain example embodiments.

FIG. 2 illustrates another example flow diagram of communications between a user equipment and network, according to some example embodiments.

FIG. 3 illustrates an example flow chart for a method of controlling a user equipment, according to various example embodiments.

FIG. 4 illustrates an example flow chart for a method of controlling a network, according to certain example embodiments.

FIG. 5 illustrates an example flow chart for a method of controlling a network, according to certain example embodiments.

FIG. 6 illustrates an example timing diagram of position signals and measurements, according to some example embodiments.

FIG. 7 illustrates another example timing diagram of position signals and measurements, according to some example embodiments.

FIG. 8 illustrates another example timing diagram of position signals and measurements, according to some example embodiments.

FIG. 9 illustrates a set of apparatuses, according to some example embodiments, according to some example embodiments.

FIG. 10 illustrates an example of a 5G network and system architecture, according to some example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of low power high frequency accuracy positioning with a substantially extended discontinuous reception cycle.

The features, structures, or characteristics of example embodiments described throughout this specification may be combined in any suitable manner in one or more example embodiments. For example, the usage of the phrases “certain embodiments,” “an example embodiment,” “some embodiments,” “various embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

UEs may connect to a network and share information electronically over networks such as cell networks. For optimal communication with the network, it may be advantageous to have an accurate knowledge of the location of the UE. The following example embodiments may prevent positioning sessions from failing to accurately estimate a position of the UE even when the UE is in an extended discontinuous reception (eDRX) cycle with limited reception windows.

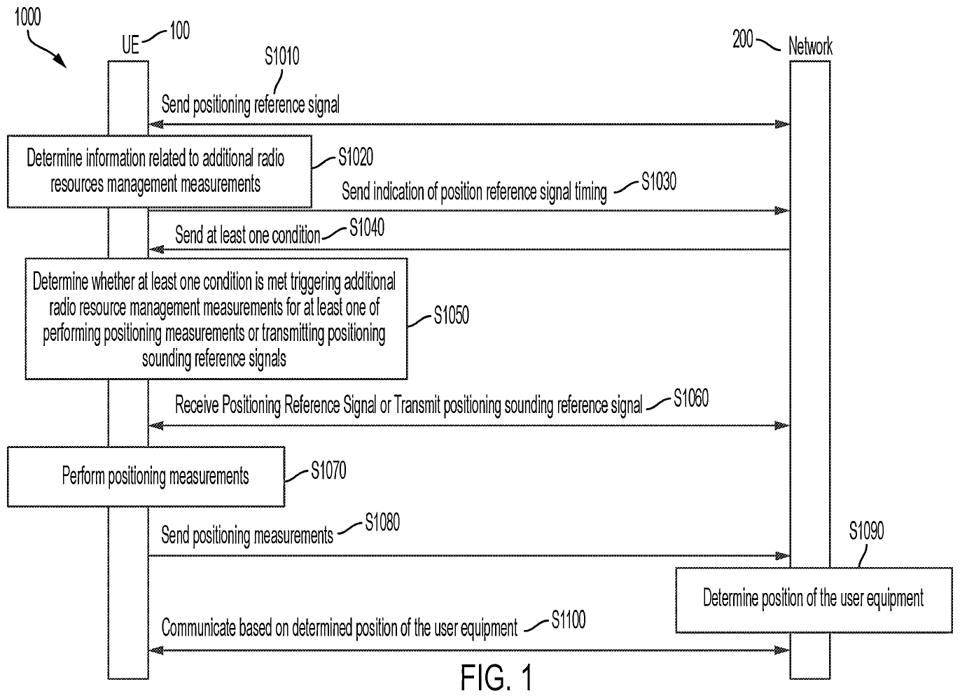

FIG. 1 illustrates an example flow diagram 1000 of communications between a user equipment (UE) 100 and network 200, according to certain example embodiments. The UE may be a user device such as a cell phone, computer, laptop, tablet, etc. The network 200 may be a 5G network or other network including base stations, servers, location management function (LMF) implemented on a server or other hardware, etc.

At S1020, the network 200 (at a base station) may send a positioning reference signal (PRS) or series of positioning reference signals to the UE 100. The UE 100 may receive the positioning reference signal. The network 200 may send PRS periodically, and the PRS may be used for positioning various devices connected to the network 200. The UE 100 may be in an extended discontinuous reception (eDRX) cycle where the UE 100 only processes signals received during a periodic paging time window (PTW) in each cycle of the eDRX cycle. The UE 100 may be in the eDRX for power saving. If a second PRS is not received in the PTW, the UE 100 may not be able to perform positioning measurements on the PRS. Thus, the positioning interval of the PRS may be too large and/or may not be synchronized with the eDRX cycle of the UE 100.

At S1020, the UE 100 may determine information related to additional radio resources management measurements. PRS is an example of radio resources management (RRM). The UE 100 may determine that the PRS signaling is received too infrequently or out of synch with the PTW such that there is a synchronization failure.

The UE 100 may determine that the UE 100 is out of the synchronization and measure neighbor cells for cell reselection. The UE 100 may perform serving cell measurement/reference cell measurements. If serving cell/reference cell measurements failed, or if the UE is out of synchronization, UE 100 may perform neighboring cell measurements. If reselection conditions are satisfied, cell reselection may be performed.

At S1030, the UE 100 may send, to the network 200, an indication of position reference signal timing. The indication may include an indication of synchronization failure, or another indication that the PRS is received in a way that positioning measurements in the PTW of the eDRX cycle is hindered.

At S1040, the network 200 may send and the UE 100 may receive at least one condition triggering additional radio resource management measurements for at least one of performing positioning measurements or transmitting positioning sounding reference signals. The network 200 at the LMF may determine which condition(s) to send. The at least one condition may include UE conditions, channel conditions, signal conditions, measurement requirements, etc. In some embodiments some or all of the conditions may be stored at the UE 100 and operations S1030 and S1040 may be skipped.

The at least one condition may include, performing the additional measurement(s) when the UE 100 may be in a time duration of sleeping mode. For example, the downlink (DL) PRS positioning measurement or transmits uplink (UL) positioning SRS(s) is outside of a PTW. The at least one condition may include, performing the additional measurement(s) when UE mobility is over a certain threshold (e.g., the UE performs additional RRM measurements if the UE mobility is high, and the UE may not necessarily perform additional RRM measurements if the UE mobility is low). The at least one condition may include, performing the additional measurement(s) when the received signal power (e.g., reference signal received power (RSRP), reference signal received quality (RSRQ), signal to interference and noise ratio (SINR)) of the recently measured synchronization signal block (SSB) does not exceed a certain threshold (e.g., the UE performs additional RRM measurements if the most recent RSRP measurement from SSB is low).

In some other examples of the at least one condition, the UE 100 may measure the closest SSB before performing the PRS measurement if the next PRS measurement occasion is not overlapping with any PTW of the eDRX cycle. The network 200 also may expect or anticipate this UE 100 behavior and send the PRS at the normal interval so that the PRS can be anticipated by the UE 100. If the UE is indicated to obtain highly accurate positioning measurements, the network expects or anticipates the UE to increase the number of additional RRM measurement samples outside of the PTW. The at least one condition may include, performing the additional measurement(s) when a high accuracy of positioning measurement is required, the RRM measurement frequency can further increase. For example, when UE is set to measure two samples for additional RRM measurement, UE may determine to measure four SSB samples to enhance the accuracy of synchronization. The at least one condition may include, performing the additional measurement(s) when the wireless channel measurement (e.g., quality of service class identifier (CQI), RSRP, and/or SINR) between the UE and the gNB is less than a pre-defined threshold, the UE may perform additional RRM measurement outside of the PTW. The UE may perform the SSB measurement before the next, upcoming PRS measurements until the PRS measurement occasion is overlapping with the next, second PTW. If downlink reference timing and/or uplink transmission timing is changed over a pre-defined threshold value, the UE 100 may perform the additional RRM measurements outside of the PTW before the next PRS measurement. The substantial change of the downlink reception reference timing may happen if the UE 100 moves to another cell within a validity area.

Additional RRM measurements may also be configured. A RRM measurement frequency may be initially defined to a certain value (e.g., one SSB measurement in every X (>0) PRS measurements outside PTW). The RRM measurement frequency can be implemented as an additional RRM (SSB) measurement period. For example, the value of the RRM measurement frequency can be lower with an extended cyclic prefix (CP) length than a short CP length. This is due to the fact that extended CP is robust to maintain synchronization, and thus less frequency RRM measurement is required when extended CP is configured. This may be combined with other options from the one or more conditions.

At S1050, the UE 100 may determine whether the at least one condition is met triggering additional RRM measurements for at least one of performing positioning measurements or transmitting positioning sounding reference signal (SRS). SRS is another example of RRM.

At S1060, the UE 100 and/or the network 200 may send RRM signals. The UE 100 may receive one or more PRS from the network or transmit the PSR signal to the network 200.

At S1070, the UE 100 may perform positioning measurements based on the RRM signals. The one or more PRS may be measured outside of the PTW of the eDRX. The positioning measurements may include time of arrival (ToA), signal strength measurements, channel quality measurements, or other measurements which are useful for determining positioning of the UE.

At S1080, the UE 100 may send the positioning measurements to the network 200.

At S1090, the network 200 at the LMF may determine the position of the UE 100. In an example embodiment, the gNB of the network 200 receives the positioning measurements from UE 100 at S1080 and provides the positioning measurements to the LMF of the network 200. The LMF determines the position of the UE based on the positioning measurements from the UE 100. In another example embodiment, the UE 100 transmits positioning SRS and a base station (gNB) of the network 200 receives the positioning SRS. The gNB of the network 200 performs positioning measurements such as RTOA (Relative Time Of Arrival) and provides the LMF of the network 200 with the obtained measurements. The LMF of the network 200 determines the position of the UE 100 based on the obtained measurements from the gNB of the network 200.

At S1100, the LMF of the network may establish communication conditions with the UE 100 based on the determined position and UE 100 and network 200 may communicate.

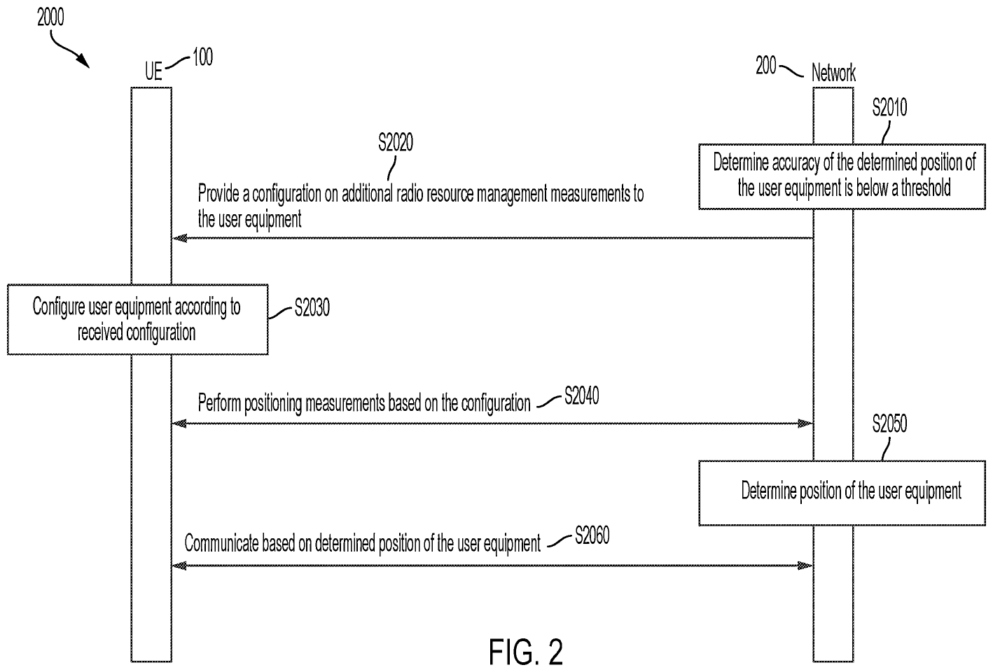

FIG. 2 illustrates another example flow diagram 2000 of communications between a user equipment and network, according to some example embodiments. The operations of FIG. 2 may be performed in conjunction with the operations of FIG. 1. For example, the operations of FIG. 2 may be performed after the operations of FIG. 1.

At S2010, the LMF of the network 200 may determine that the accuracy of the determined position of the user equipment 100 is below a threshold. The threshold may be set based on the requirement of the positioning accuracy, measurement quality reported by the user equipment, types of communications, the quality of the connection, network conditions, etc.

At S2020, the network 200 may send and the UE 100 may receive a configuration on additional RRM measurements from a gNB of the network 200. For example, the gNB of the network 200 will provide a configuration for performing a series of RRM measurements which may or may not align with the eDRX cycle of the UE 100.

At S2030, the UE 100 may configure the UE 100 to receive the PRS at the timing indicated in the configuration. The UE 100 may reconfigure the eDRX cycle to align the PTW with the PRS to be received or may reconfigure to perform the measurements outside of the PTW. In an example embodiment, explicit indication on additional RRM measurements may be included in the configuration from the LMF or gNB of the network 200. Network 200 activates the additional RRM measurements via a RRC signaling. When additional RRM measurements are not activated, if UE is out of synchronization, UE changes the RRC state to the CONNECTED mode and the new cell is searched. When additional RRM measurements are activated, as an initialization, UE determines the number of PRS measurements and the corresponding period of additional RRM measurements.

At S2040, the UE 100 and the network 200 may perform positioning measurements based on the configuration. The UE 100 may receive PRS and perform RRM measurements based on the PRS, the UE may also send SRS. The UE 100 may send the measurements to the network 200.

At S2050, the network 200 may determine the position of the UE 100.

As S2060, the network 200 may communicate with the UE 100 based on the determined position of the user equipment.

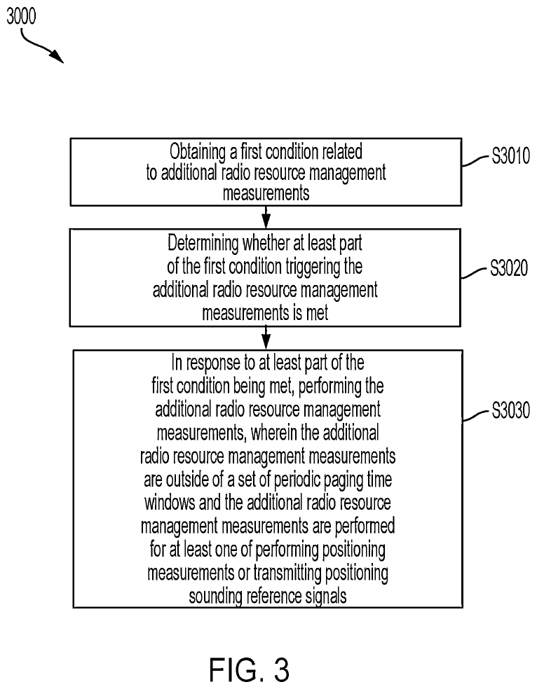

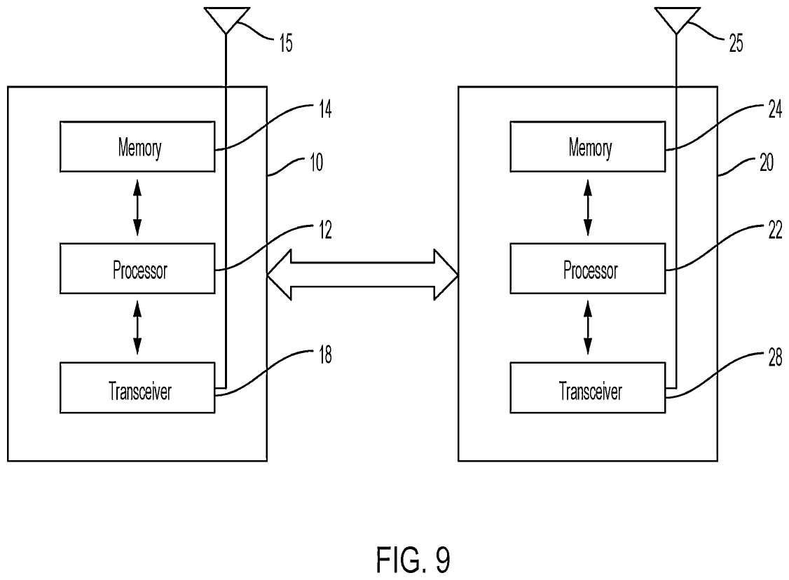

FIG. 3 illustrates an example flow diagram 3000 of a method, according to certain example embodiments. In an example embodiment, the method of FIG. 3 may be performed by a network entity, or a group of multiple network elements (NE) in a 3GPP system, such as LTE or 5G-NR. For instance, in an example embodiment, the method of FIG. 3 may be performed by a UE or computer implementing an application and/or AF, the UE and computer being similar to one of apparatuses 10 or 20 illustrated in FIG. 9.

According to certain example embodiments, the method of FIG. 3 may include, at S3010, obtaining a first condition related to additional radio resource management measurements, at S3020, determining whether at least part of the first condition triggering the additional radio resource management measurements is met, and, at S3030 in response to at least part of the first condition being met, performing the additional radio resource management measurements, wherein the additional radio resource management measurements are outside of a set of periodic paging time windows and the additional radio resource management measurements are performed for at least one of performing positioning measurements or transmitting positioning sounding reference signals.

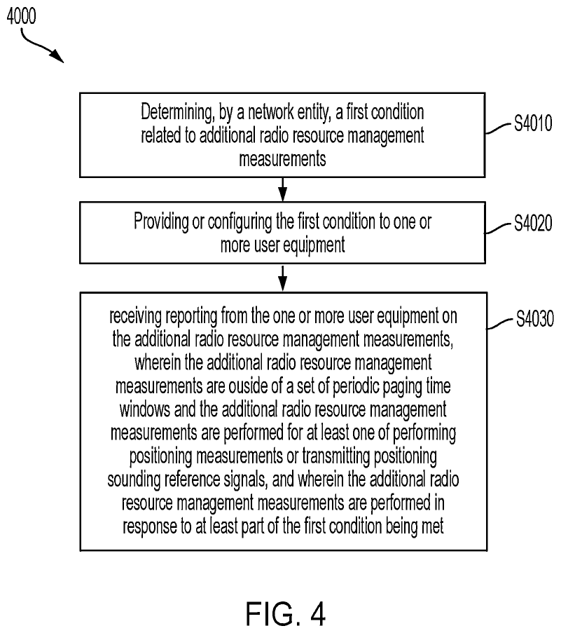

FIG. 4 illustrates an example flow diagram 4000 of another method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by the network (e.g., gNB, 5G core, or 5G RAN) similar to one of apparatuses 10 or 20 illustrated in FIG. 9.

According to certain example embodiments, the method of FIG. 4 may include, at S4010, determining, by a network entity, a first condition related to additional radio resource management measurements, at S4020, providing or configuring the first condition to one or more user equipment, at S4030, receiving reporting from the one or more user equipment on the additional radio resource management measurements, wherein the additional radio resource management measurements are outside of a set of periodic paging time windows and the additional radio resource management measurements are performed for at least one of performing positioning measurements or transmitting positioning sounding reference signals, and wherein the additional radio resource management measurements are performed in response to at least part of the first condition being met.

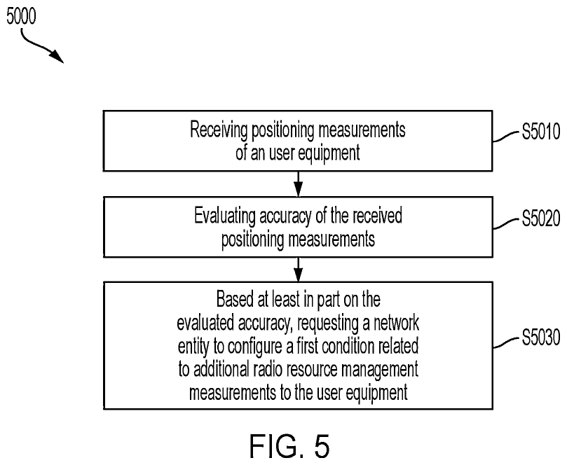

FIG. 5 illustrates an example flow chart for a method of controlling a network, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a network element implementing an LMF similar to one of apparatuses 10 or 20 illustrated in FIG. 9.

According to certain example embodiments, the method of FIG. 5 may include, at S5010, receiving positioning measurements of a user equipment, at S5020, evaluating accuracy of the received positioning measurements, and at S5030, based at least in part on the evaluated accuracy, requesting a network entity to configure a first condition related to additional radio resource management measurements to the user equipment.

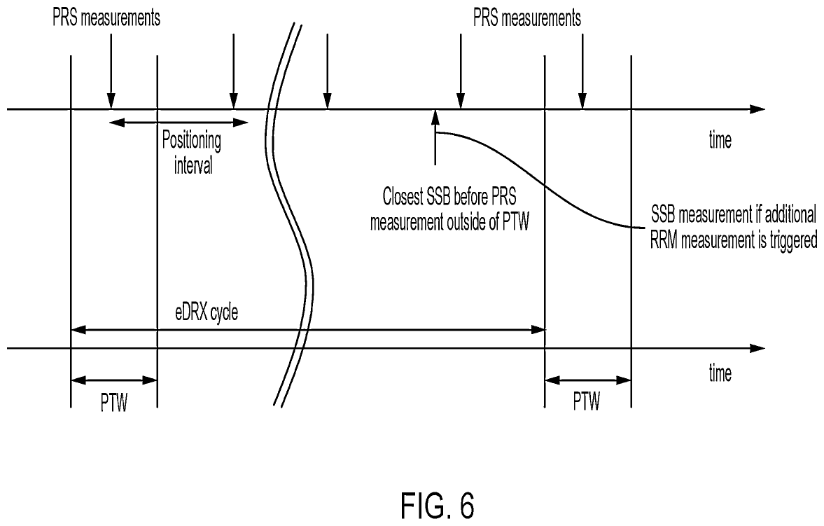

FIG. 6 illustrates an example timing diagram of position signals and measurements, according to some example embodiments. The timing diagram shows RRM signals and the eDRX cycle of the UE 100. The timing diagram also illustrates the positioning interval between the PRS signals and potential measurements at the UE 100. The timing diagram of FIG. 6 shown an example of one of the options for performing RRM signaling and measurements outside of the PTW of the eDRX cycle. The UE 100 may determine the next PRS measurement occasion is not overlapping with any PTW measure and measure an SSB before the PRS closest before the PTW of the eDRX cycle. The network 200 also may expect or anticipate this UE 100 behavior and send the PRS at the normal interval so that the PRS can be anticipated by the UE 100. Accordingly, RRM measurements may be performed by the UE 100. The PRS measurements may also be replaced with positioning SRS transmission.

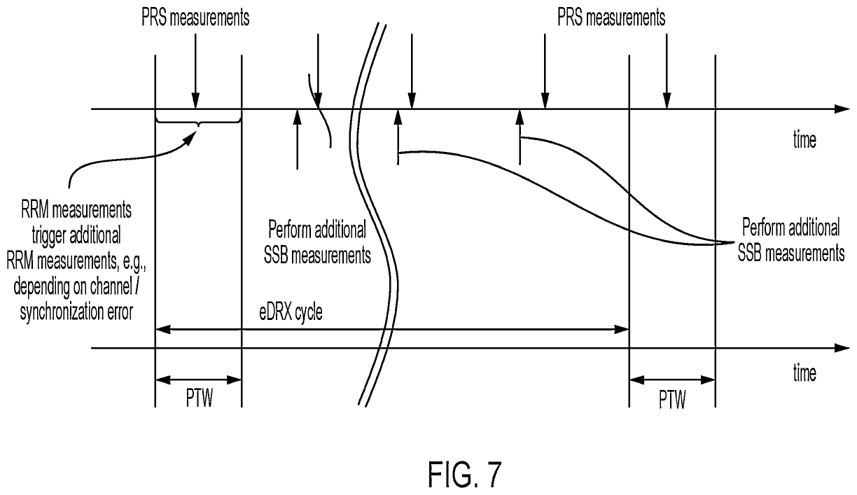

FIG. 7 illustrates another example timing diagram of position signals and measurements, according to some example embodiments. the UE 100 determines a high accuracy of positioning measurement is required, the RRM measurement frequency can further increase (e.g., to four) and the UE may determine to measure four SSB samples to enhance the accuracy of synchronization. SSB samples may be measured outside of the PTW window.

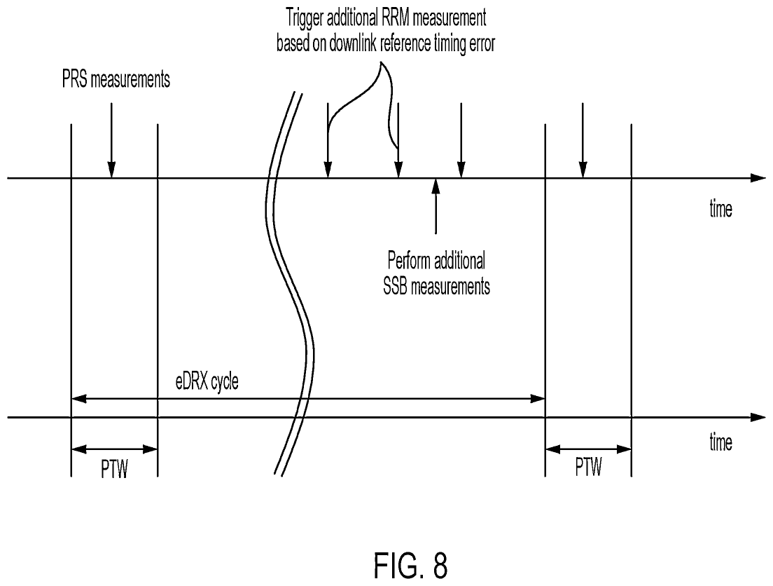

FIG. 8 illustrates another example timing diagram of position signals and measurements, according to some example embodiments. If the UE determines the downlink reference timing and/or uplink transmission timing is changed over a pre-defined threshold value (e.g., a downlink reference timing error occurs), the UE 100 may perform the additional RRM measurements outside of the PTW by performing SSB measurements.

FIG. 9 illustrates a set of apparatuses 10 and 20 according to certain example embodiments. In certain example embodiments, apparatuses 10 and 20 may be elements in a communications network or associated with such a network. For example, apparatus 10 may be an AF or application implemented on a computing device or machine such as, for example, an EH-UE, and apparatus 20 may be a network (i.e., gNB, 5GS, 5G Core, 5G RAN, etc.).

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 9.

As illustrated in the example of FIG. 9 apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processors 12 and 22 is shown in FIG. 9, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-8.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-8.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

In certain example embodiments, apparatus 10 may be controlled by memory 14 and processor 12 to send an energy report to a network element, the energy report indicating limitations of energy of a device, generate a positioning measurement report based on signals received from one or more base stations, and send the positioning measurement report to the network element.

In other example embodiments, apparatus 20 may be controlled by memory 24 and processor 22 to determine, at least one parameter with which to conduct a positioning estimation process based on an energy report received from a device. The energy report may indicate limitations of energy of the device. The apparatus 20 may also be controlled by memory 24 and processor 22 to control one or more base stations to conduct the positioning estimation process with the device based on the determination of the at least one parameter, and estimate a position of the device based on a positioning measurement report received from the device.

Certain example embodiments may be directed to an apparatus that includes means for sending an energy report to a network element. The energy report may indicate limitations of energy of a device. The apparatus may also include means for generating a positioning measurement report based on signals received from one or more base stations, and means for sending the positioning measurement report to the network element.

Other example embodiments may be directed to an apparatus that includes means for determining at least one parameter with which to conduct a positioning estimation process based on an energy report received from a device. The energy report may indicate limitations of energy of the device. The apparatus may also include means for controlling one or more base stations to conduct the positioning estimation process with the device based on the determination of the at least one parameter, and means for estimating a position of the device based on a positioning measurement report received from the device.

Certain example embodiments described herein provide several technical improvements, enhancements, and/or advantages. In some example embodiments, it may be possible to obtain the position of a device without having an error due to the energy of the device being completely depleted. Also, the positioning process may be customized for the particular device based on the constraints and needs of the device. Further, errors can be reduced by allowing pauses in the positioning process for the device to harvest energy.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

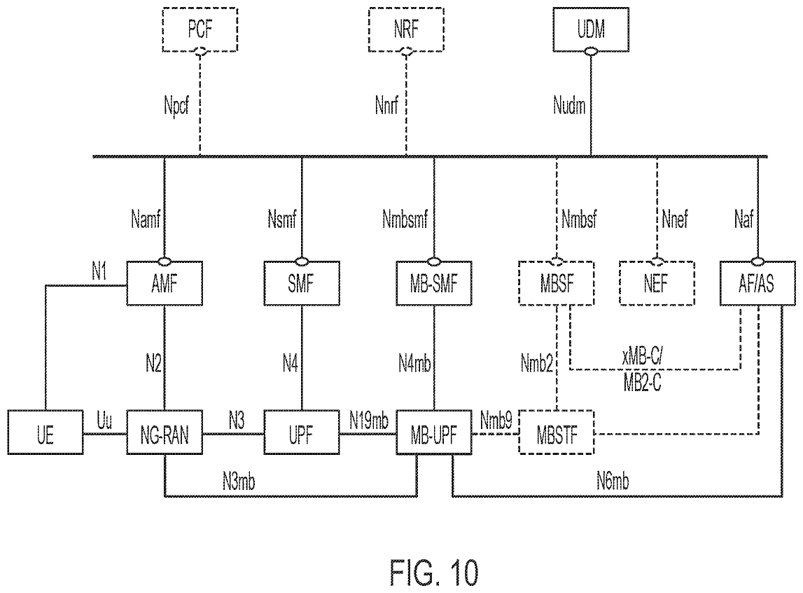

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to apparatuses 20 and 10, respectively. The user plane function (UPF) may provide services such as intra-RAT and inter-RAT mobility, routing and forwarding of data packets, inspection of packets, user plane quality of service (QOS) processing, buffering of downlink packets, and/or triggering of downlink data notifications. The application function (AF) may primarily interface with the core network to facilitate application usage of traffic routing and interact with the policy framework.

According to certain example embodiments, processors 12 and 22, and memories 14 and 24, may be included in or may form a part of processing circuitry or control circuitry. In addition, in some example embodiments, transceivers 18 and 28 may be included in or may form a part of transceiving circuitry.

In some example embodiments, an apparatus (e.g., Apparatus 10 and/or Apparatus 20) may include means for performing a method, a process, or any of the variants discussed herein. Examples of the means may include one or more processors, memory, controllers, transmitters, receivers, and/or computer program code for causing the performance of the operations.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary

| | |
|---|---|
| 3GPP | 3rd Generation Partnership Project |
| 5G | 5th Generation |
| 5GCN | 5G Core Network |
| AF | Application Function |
| BS | Base Station |
| DL | Downlink |
| eNB | Enhanced Node B |
| gNB | 5G or Next Generation NodeB |
| LTE | Long Term Evolution |
| NM | Network Manager |
| NR | New Radio |
| UE | User Equipment |
| gNB | 5G Base Station |
| LMF | Location Management Function |
| PRS | Positioning Reference Signal |
| SRS | Sounding Reference Signal |
| UL | Uplink |
| PFL | Positioning Frequency Layer |
| LPP | LTE Positioning Protocol |
| NRPPa | NR Positioning Protocol a |
| RSTD | Reference Signal Time Difference |
| RTOA | Relative Time Of Arrival |
| QCL | Quasi-colocation |
| Rx | Receive/Reception |
| Tx | Transmit/Transmission |
| PTW | Paging Time Window |

1.-38. (canceled)

39. A method comprising:
receiving, by a user equipment, a positioning reference signal;
obtaining a first condition related to additional radio resource management measurements, wherein the first condition comprises the following: the user equipment is in a sleep mode, mobility of the user equipment exceeds a first threshold, a next positioning reference signal measurement occasion or sounding reference signal transmission occasion is outside of a periodic paging time windows, a positioning accuracy above a second threshold is required, wireless channel condition or quality is less than a third threshold, synchronization error is outside of a first range, and downlink reception reference timing or uplink transmission reference timing is changed over a fourth threshold;
determining whether the first condition triggering the additional radio resource management measurements is met; and
in response to the first condition being met, performing the additional radio resource management measurements, wherein performing the additional radio resource management measurements comprise:
performing positioning measurements and transmitting positioning sounding reference signals,
performing radio resource management measurements with a synchronization signal block before performing at least one of downlink positioning reference signal measurements or transmission of a positioning sounding reference signal; and
performing the radio resource management measurements from the synchronization signal block before a positioning reference signal measurement occasion and a positioning sounding reference signal transmission occasion overlaps with a second paging time window.

40. The method of claim 39, wherein the first condition related to additional radio resource management measurements is received from a network entity.

41. The method of claim 39, wherein the first condition related to additional radio resource management measurements is pre-defined.

42. The method of claim 41, further comprising:
sending an indication of synchronization failure to a network; and
receiving the first condition from the network.

43. The method of claim 42, further comprising:
changing radio resource management measurement frequency based on a second condition.

44. The method of claim 43, wherein the second condition comprises cyclic prefix length increasing above a first threshold and user equipment mobility increasing above a second threshold.

45. The method of claim 44, wherein the additional radio resource management measurements are performed when a received signal power of a recently measured synchronization signal block (SSB) does not exceed a threshold.

46. A user equipment comprising:
a processor; and
a memory comprising computer executable instructions that, when executed by the processor, cause the user equipment to perform the following operations:
receiving a positioning reference signal;
obtaining a first condition related to additional radio resource management measurements, wherein the first condition comprises the following: the user equipment is in a sleep mode, mobility of the user equipment exceeds a first threshold, a next positioning reference signal measurement occasion or sounding reference signal transmission occasion is outside of a periodic paging time windows, a positioning accuracy above a second threshold is required, wireless channel condition or quality is less than a third threshold, synchronization error is outside of a first range, and downlink reception reference timing or uplink transmission reference timing is changed over a fourth threshold;
determining whether the first condition triggering the additional radio resource management measurements is met; and
in response to the first condition being met, performing the additional radio resource management measurements, wherein performing the additional radio resource management measurements comprise:
performing positioning measurements and transmitting positioning sounding reference signals,
performing radio resource management measurements with a synchronization signal block before performing at least one of downlink positioning reference signal measurements or transmission of a positioning sounding reference signal; and
performing the radio resource management measurements from the synchronization signal block before a positioning reference signal measurement occasion and a positioning sounding reference signal transmission occasion overlaps with a second paging time window.

47. The user equipment of claim 46, wherein the first condition related to additional radio resource management measurements is received from a network entity.

48. The user equipment of claim 46, wherein the first condition related to additional radio resource management measurements is pre-defined.

49. The user equipment of claim 48, wherein the computer-executable instructions further cause the user equipment to perform the following operations:
sending an indication of synchronization failure to a network; and
receiving the first condition from the network.

50. The user equipment of claim 49, wherein the computer-executable instructions further cause the user equipment to perform the following operation:
changing radio resource management measurement frequency based on a second condition.

51. The user equipment of claim 50, wherein the second condition comprises cyclic prefix length increasing above a first threshold and user equipment mobility increasing above a second threshold.

52. The user equipment of claim 51, wherein the additional radio resource management measurements are performed when a received signal power of a recently measured synchronization signal block (SSB) does not exceed a threshold.

53. A system comprising:
a user equipment;
a processor; and
a memory comprising computer executable instructions that, when executed by the processor, cause the user equipment to perform the following operations:
receiving a positioning reference signal;
obtaining a first condition related to additional radio resource management measurements, wherein the first condition comprises the following: the user equipment is in a sleep mode, mobility of the user equipment exceeds a first threshold, a next positioning reference signal measurement occasion or sounding reference signal transmission occasion is outside of a periodic paging time windows, a positioning accuracy above a second threshold is required, wireless channel condition or quality is less than a third threshold, synchronization error is outside of a first range, and downlink reception reference timing or uplink transmission reference timing is changed over a fourth threshold;
determining whether the first condition triggering the additional radio resource management measurements is met; and
in response to the first condition being met, performing the additional radio resource management measurements, wherein performing the additional radio resource management measurements comprise:
performing positioning measurements and transmitting positioning sounding reference signals,
performing radio resource management measurements with a synchronization signal block before performing at least one of downlink positioning reference signal measurements or transmission of a positioning sounding reference signal; and
performing the radio resource management measurements from the synchronization signal block before a positioning reference signal measurement occasion and a positioning sounding reference signal transmission occasion overlaps with a second paging time window.

54. The system of claim 53, wherein the first condition related to additional radio resource management measurements is received from a network entity.

55. The system of claim 53, wherein the first condition related to additional radio resource management measurements is pre-defined.

56. The system of claim 55, wherein the computer-executable instructions further cause the user equipment to perform the following operations:
sending an indication of synchronization failure to a network; and
receiving the first condition from the network.

57. The system of claim 56, wherein the computer-executable instructions further cause the user equipment to perform the following operation:
changing radio resource management measurement frequency based on a second condition, wherein the second condition comprises cyclic prefix length increasing above a first threshold and user equipment mobility increasing above a second threshold.

58. The system of claim 57, wherein the additional radio resource management measurements are performed when a received signal power of a recently measured synchronization signal block (SSB) does not exceed a threshold.
